(19) United States
(12) Patent Application Publication
(10) Pub. No.: US 2025/0047328 A1
(43) Pub. Date: Feb. 6, 2025

(54) SYSTEMS AND METHODS FOR ROBUST BEAMFORMING USING A RECONFIGURABLE INTELLIGENT SURFACE IN COMMUNICATION SYSTEMS

(71) Applicant: HUAWEI TECHNOLOGIES CO., LTD., SHENZHEN (CN)

(72) Inventors: Mostafa Medra, Kanata (CA); Ahmad Mustafa Musa Abu Al Haija, Ottawa (CA); Mohammadhadi Baligh, Ottawa (CA)

(21) Appl. No.: 18/799,724

(22) Filed: Aug. 9, 2024

Related U.S. Application Data
(63) Continuation of application No. PCT/CN2022/075877, filed on Feb. 10, 2022.

(51) Int. Cl. H04B 7/04; H04B 17/309

(52) U.S. Cl. CPC H04B 7/04013; H04B 17/346

(57) ABSTRACT

Methods, devices, and computer-readable media are provided that enable a reconfigurable intelligent surface (RIS) to shape a beam being redirected by the RIS for robustness whether the RIS is integrated at a transmitter, such as a base station or a user equipment (UE), or the RIS is a separate entity from the transmitter. An example method includes beamforming the signal to be transmitted, the beamforming comprising applying beam coefficients to a transmitter. The example method further includes determining configuration information for a reconfigurable intelligent surface (RIS) enabling modification of the signal that impinges on the RIS. The configuration information for the RIS pertains to beam direction, beam shape, and beam robustness of the redirected beam.

### CROSS REFERENCE TO RELATED APPLICATION

The present application is a continuation of International Application No. PCT/CN2022/075877, filed on Feb. 10, 2022, the disclosure of which is hereby incorporated by reference in its entirety.

### TECHNICAL FIELD

The present disclosure relates generally to wireless communications, and in particular embodiments, use of reconfigurable intelligent surfaces (RIS) in communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Metasurfaces have been investigated in optical systems for some time and recently have attracted interest in wireless communication systems. These metasurfaces are capable of affecting a wavefront that impinges upon them. Some types of these metasurfaces are controllable, meaning through changing the electromagnetic properties of the surface, the properties of the surface can be changed. For example, manipulation of the amplitude and/or phase can be achieved by changing an impedance or relative permittivity (and/or permeability) of the metamaterial. An example of a metasurface is a reconfigurable intelligent surface (RIS).

A controllable RIS can affect the environment and effective channel coefficients of a channel of which the RIS is a part thereof. This results in the channel being represented as the combination of an incoming wireless channel and an outgoing wireless channel and the phase/amplitude response of the configurable RIS.

When a transmitting communication device, such as a base station, has multiple antennas, analog beamforming may be used to provide beamforming gain that may result in an improved signal to noise ratio (SNR) at a receiving communication device, such as a UE. This may be performed by having a radio frequency (RF) chain connected to multiple antennas through phase shifters. The phases of these phase shifters are adjusted to provide a beam with a transmission peak in a certain direction, thus improving a communication link in the given direction. There may be more than one RF chain, each of which may be performing analog beamforming. A phase shift vector including the phases for the respective antennas forms a beam in a certain direction, and a collection of these vectors can be called a codebook. Analog beamforming is useful for providing additional gains that can combat the channel path loss in multi-antenna systems. One of the most common analog beamforming methods is using a discrete Fourier transformation (DFT) matrix, where a number of rows of the DFT matrix is the same as a number of antennas. Extended DFT matrices can be used that have more directions than a typical DFT matrix. The phase values change linearly across the antenna elements.

One parameter of a transmitted beam is beam robustness. Robust beams typically have lower performance degradation than non-robust beams, where the performance refers to beamforming gain. The robustness of a beam may be defined by multiple factors, one of which includes beamwidth, which relates the performance to a span of degrees of the beam. One type of robust beam is a chirp beam that allows control over the beamwidth in a trade-off with a peak beam gain. Chirp beams include phases that are a linear function of the antenna location which define the beam direction, and phases that are a quadratic function of the antenna location that define the robustness.

One way of obtaining beamforming gains is through the use of RISs. The phase shifts can be controlled to provide high beamforming gain in a certain direction.

### SUMMARY

Aspects of the present disclosure provide methods and device for utilizing RIS panels in the wireless network to take advantage of the RIS capabilities, intelligence, coordination and speed, and thereby propose solutions having different signaling details and capability requirements.

When the RIS is provided with information that enables robust reflection of the beam towards the receiver, a communication link between a transmitter and receiver may be robust to the uncertainty in collected information about the receiver location or receiver movements. This may provide improved performance in terms of higher signal-to-noise ratio (SNR) when the receiver moves, or compared to the performance when non-robust beams are used.

According to an aspect, there is provided a method of analog beamforming a signal involving: beamforming the signal to be transmitted by a transmitter, the beamforming including applying beam coefficients to the transmitter; determining configuration information for a reconfigurable intelligent surface (RIS) enabling modification of the signal transmitted by the transmitter that impinges on the RIS; wherein the configuration information for the RIS pertains to beam direction, beam shape and beam robustness of the redirected beam.

In some embodiments, when the RIS is co-located with the transmitter, the method further involves using the configuration information to configure the RIS.

In some embodiments, when the RIS is located separately from the transmitter, the method further involves transmitting the configuration information to the RIS.

In some embodiments, the method further involves using the configuration information received by the RIS to determine a configuration for elements of the RIS to redirect the beamformed signal.

In some embodiments, the configuration information used by the RIS to determine the configuration for the elements of the RIS includes chirp beam information pertaining to the beam direction that is a linear function of indices of the elements of the RIS and information pertaining to the beam robustness that is a polynomial function of indices of the elements of the RIS.

In some embodiments, a direction of the beam robustness is a straight line, a curved line, or an arc.

In some embodiments, determining the configuration information for the RIS involves determining a phase compensation component for at least one of: when phase compensation is needed related to a distance between the RIS and the transmitter; or when phases of the beamformed signal impinging on the RIS do not have uniform phase spacing.

In some embodiments, the method further involves: determining additional configuration information for the RIS due to a change in conditions; and using, by the RIS, the additional configuration information in combination with the configuration information to determine a new configuration for elements of the RIS to redirect the signal transmitted by the transmitter.

According to an aspect, there is provided a method for use in beam management involving determining, by a base station, configuration information for redirecting a beamformed signal transmitted by a transmitter by a RIS, wherein the configuration information pertains to beam direction, beam shape and beam robustness of the redirected beam.

In some embodiments, when the RIS is located separately from the transmitter, the method further involves transmitting the configuration information to the RIS.

In some embodiments, the configuration information for redirecting the beamformed signal transmitted by the transmitter by the RIS is defined by parameters including one or more of: an angle defining a beam center; parameter defining a beam width; and a shape representing a desired robustness shape.

In some embodiments, transmitting the configuration information to the RIS involves: transmitting information for configuring the RIS regarding beam direction separately from information for configuring the RIS regarding beam robustness; transmitting information for configuring the RIS regarding beam direction in combination with information for configuring the RIS regarding beam robustness; transmitting information for configuring the RIS regarding phase compensation for other factors; transmitting information in terms of polynomial function coefficients that the RIS can use to obtain the phases for beam direction, beam shape, beam robustness, beam phase compensation, or a combination thereof; or transmitting information to control amplitude of the signal impinging in addition to modifying the phase.

In some embodiments, the method further involves receiving, by the base station, user equipment (UE) parameter information for use in determining configuration information for beamforming the signal via the RIS.

In some embodiments, the UE parameter information for use in determining the configuration information is one or more of: a velocity of the UE; a direction of movement of the UE; a location of the UE; interference measured at the UE; a signal-to-noise ratio (SNR) calculated at the UE; or uncertainty of one or more of the velocity of the UE, the direction of movement of the UE, the location of the UE, interference measured at the UE, or the SNR ratio calculated at the UE.

In some embodiments, determining the configuration information is performed for more than one beam.

In some embodiments, determining the configuration information for more than one beam involves determining configuration information for a first beam for initial access and for a second beam for refinement beam sweeping between a transmitter and a receiver.

In some embodiments, determining configuration information for the RIS includes determining a phase compensation component for at least one of: when phase compensation is needed related to a distance between the RIS and the transmitter; or when phases of the beamformed signal impinging on the RIS do not have uniform phase spacing.

In some embodiments, the method further involves determining, by a base station, additional configuration information for the RIS due to a change in conditions that can be used by the RIS in combination with the configuration information to determine a new configuration for elements of the RIS to redirect the signal transmitted by the transmitter.

According to an aspect, there is provided a device including a processor and a computer-readable medium. The computer-readable medium has stored thereon, computer executable instructions, that when executed cause the processor to perform the method as described above or detailed below.

According to an aspect, there is provided a method for use in beam management involving: receiving, by a RIS, configuration information for redirecting a beamformed signal transmitted by a transmitter by the RIS; and configuring, by the RIS, the elements of the RIS to redirect the beamformed signal based on the received configuration information; wherein the configuration information pertains to beam direction, beam shape and beam robustness for a beam impinging on and being redirected by the RIS.

In some embodiments, the configuration information for redirecting the beamformed signal transmitted by the transmitter by the RIS is based on one or more of: an angle defining a beam center; a parameter defining a beam width; or a shape representing a desired robustness shape.

In some embodiments, the configuration information for redirecting the beamformed signal transmitted by the transmitter by the RIS is based on one or more of: a velocity of a UE; a direction of movement of the UE; a location of the UE; interference measured at the UE; a SNR calculated at the UE; uncertainty of one or more of the velocity of the UE, the direction of movement of the UE, the location of the UE, interference measured at the UE, or the SNR calculated at the UE.

In some embodiments, receiving the configuration information at the RIS involves: receiving information for configuring the RIS regarding beam direction separately from information for configuring the RIS regarding beam robustness; receiving information for configuring the RIS regarding beam direction in combination with information for configuring the RIS regarding beam robustness; receiving information for configuring the RIS regarding phase compensations for other factors; receiving information in terms of polynomial function coefficients that the RIS can use to obtain the phases for beam direction, beam shape, beam robustness, beam phase compensation, or a combination thereof; or receiving information to control amplitude of the signal impinging in addition to modifying the phase.

In some embodiments, receiving the configuration information for redirecting the beamformed signal involves receiving configuration information for more than one beam.

In some embodiments, the configuration information for more than one beam involves configuration information for a first beam for initial access and for a second beam for refinement beam sweeping between a transmitter and a receiver that the RIS is redirecting the beamformed signal toward.

In some embodiments, the configuration information received from the base station enables a first UE to communicate with a second UE using a sidelink communication link via the RIS.

In some embodiments, the method further involves: receiving, by the RIS, additional configuration information due to a change in conditions; and using, by the RIS, the additional configuration information in combination with the configuration information to determine a new configuration for elements of the RIS to redirect the signal transmitted by the transmitter.

In some embodiments, the RIS includes at least one of sensing or transmitting functionality enabling the RIS the capability to: measure a signal strength of a signal impinging on the RIS; or transmit an indication of a particular beam to be used at the transmitter.

In some embodiments, the method further involves determining, by the RIS, at least one of phase shift values or amplitude values for elements of the RIS based on received the configuration information.

In some embodiments, determining phase shift values for the elements of the RIS involves at least one of: determining phase shift values when phase compensation is needed related to a distance between the RIS and the transmitter; or determining phase shift values when phases of the beamformed signal impinging on the RIS do not have uniform phase spacing.

According to an aspect, there is provided a device including a processor and a computer-readable medium. The computer-readable medium has stored thereon, computer executable instructions, that when executed cause the processor to perform the method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2A is a schematic diagram of a communication system in which embodiments of the disclosure may occur.

FIG. 2B is another schematic diagram of a communication system in which embodiments of the disclosure may occur.

FIG. 3A is a block diagram illustrating units or modules in a device in which embodiments of the disclosure may occur.

FIG. 3B is a block diagram of an example reconfigurable intelligent surfaces (RIS).

FIG. 4 is a block diagram illustrating units or modules in a device in which embodiments of the disclosure may occur.

FIG. 5 is an example of a signaling flow diagram for signaling between a base station, a user equipment (UE), and a RIS according to an aspect of the present disclosure.

FIG. 6 is a schematic diagram illustrating a combined subarray antenna array and a RIS according to an aspect of the disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channel. To extract full potential of RIS-assisted MIMO, a system architecture and more efficient scheme are provided in the present disclosure.

An RIS may include many small reflection elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

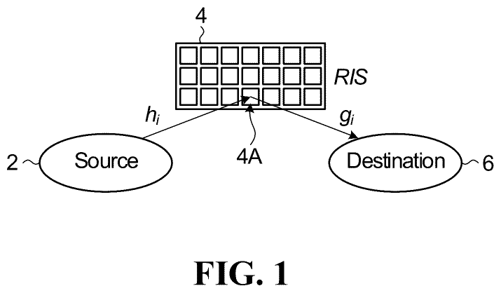

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 1 where each RIS configurable element 4a (unit cell) can change the phase of the incident wave from source such that the reflected waves from all of the RIS elements are aligned to the direction of the destination to increase or maximize its received signal strength (e.g. maximize the signal to noise ratio). Such a reflection via the RIS may be referred to as reflect-array beamforming. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

Aspects of the present disclosure provide methods and device for utilizing RIS panels in the wireless network to take advantage of the RIS capabilities, intelligence, coordination and speed, and thereby propose solutions having different signaling details and capability requirements.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hi and a channel between the RIS 4 and destination 6 identified as gi for the i^{th} RIS configurable element (configurable element 4a) where i∈{1, 2, 3, . . . , N*M} assuming the RIS consists of N*M elements or unit cells. A wave that leaves the source 2 and arrives at the RIS 4 can be said to be arriving with a particular AoA. When the wave is reflected or redirected by the RIS 4, the wave can be considered to be leaving the RIS 4 with a particular AoD. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

While FIG. 1 has two dimensional planar array RIS 4 and shows a channel h; and a channel gi, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 1, or as 2) a transmitter (integrated at the transmitter) to help implement a virtual MIMO system as the RIS helps to direct the signal from a feeding antenna.

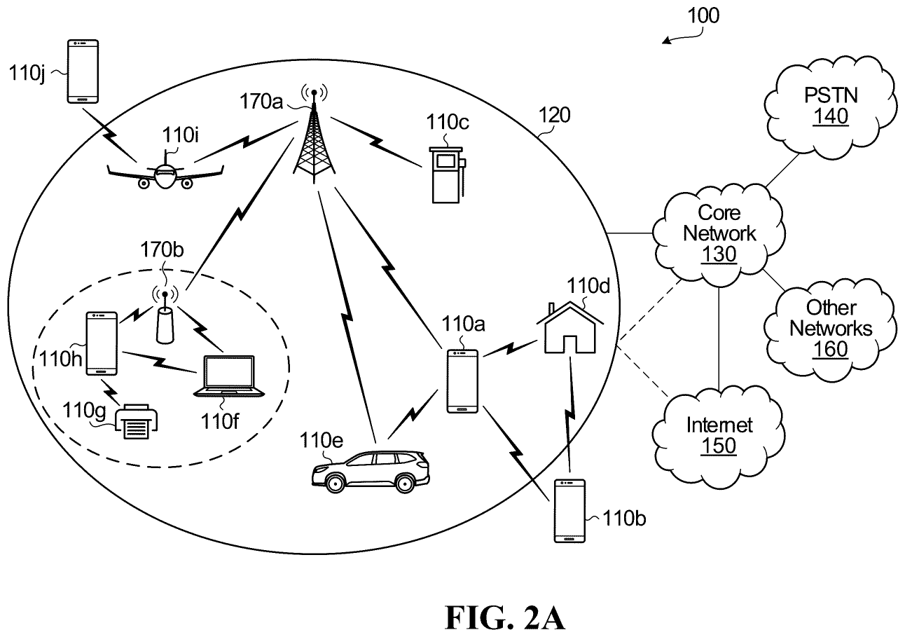

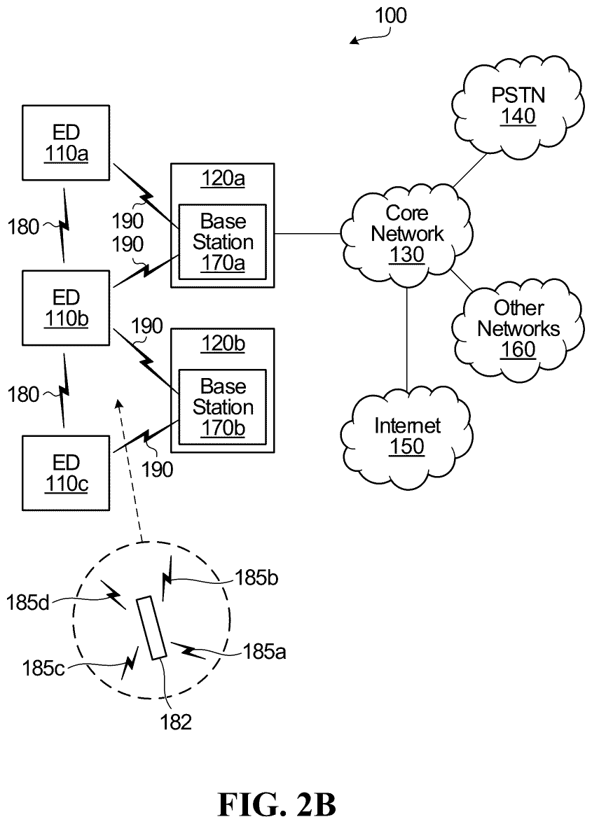

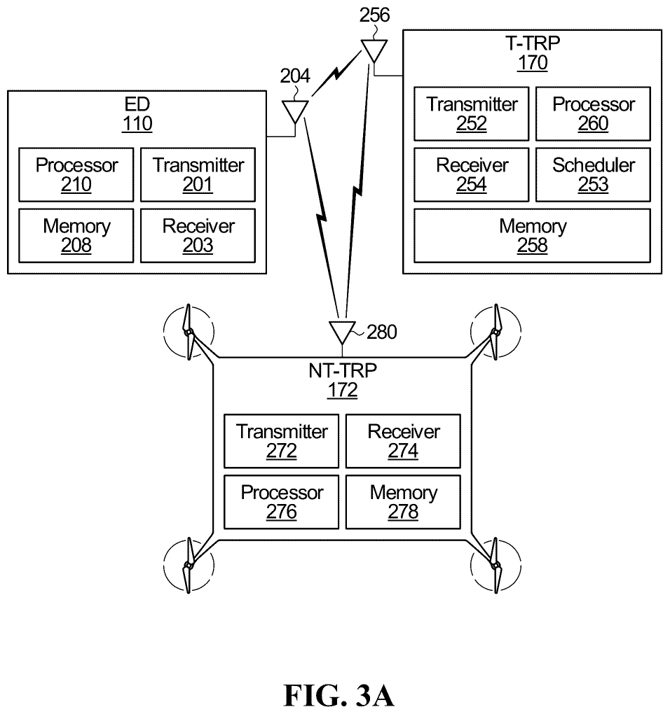

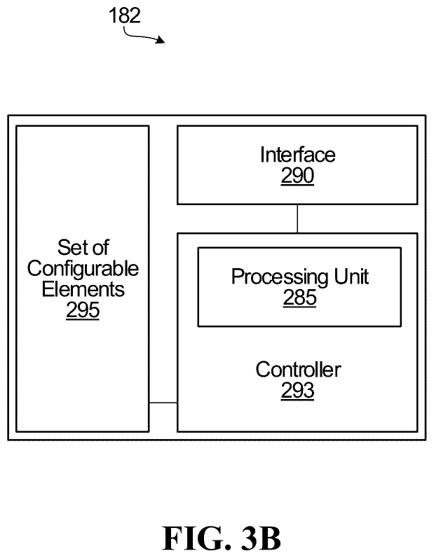

FIGS. 2A, 2B, 3A and 3B following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110c are configured to operate, communicate, or both, in the communication system 100. For example, the EDs 110a-110c are configured to transmit, receive, or both, via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 170a-170b may be a non-terrestrial base station that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110c may be alternatively or additionally configured to interface, access, or communicate with any other base station 170a-170b, the internet 150, the core network 130, the PSTN 140, the other networks 160, or any combination of the preceding.

The EDs 110a-110c and base stations 170a-170b are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In addition, some or all of the EDs 110a-110c may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

Also shown in FIG. 2B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 2B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3A. FIG. 3A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 3A, a RIS may be located between the ED 110 and the NT-TRP 172 or between the ED 110 and the T-TRP 170, in a similar manner as RIS 182 is shown between the EDs 110 and base station 170b in FIG. 2B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 3B illustrates an example RIS device that may implement the methods and teachings according to this disclosure. In particular, FIG. 3B illustrates an example RIS device 182. These components could be used in the system 100 shown in FIGS. 2A and 2B, the system shown in FIG. 3A, or in any other suitable system.

As shown in FIG. 3B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 3B. The RIS 182 ultimately uses a set of configurable elements that can be configured as described to operate herein.

FIG. 3B illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

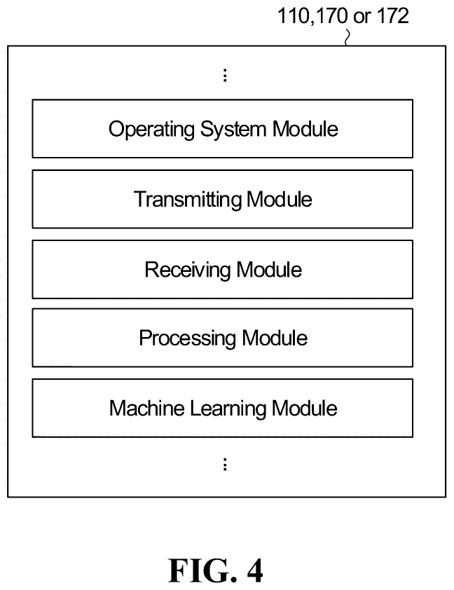

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is used so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is used so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Analog beamforming is useful for providing additional gains that can combat the channel path loss in multi-antenna systems. Analog beamforming may be performed by having a phase shifter attached to each antenna and a number of phase shifters and antennas connected in a single radio frequency (RF) chain. One of the most common analog beamforming methods is using a discrete Fourier transformation (DFT) matrix, where a number of rows of the DFT matrix is the same as a number of antennas. In this case, each column of the DFT matrix is a beamformer that points in a certain direction in space, the direction defined by an angle with respect to a reference point, and may be used to transmit or receive in that direction. In some deployments, an extended DFT matrix maybe used. The columns of the extended DFT matrix are expressed as exp(−j2παn/N), n=0, . . . , N−1 where N (an integer value) is a number of rows in the matrix and a is any number and not necessarily an integer as used in a regular DFT matrix. The phase value changes in a linear progression across the antenna elements of the array. The regular or extended DFT matrix may be referred to as a codebook. For dual polarized antenna sets, each polarization may receive its own codebook. Accordingly, each beam has a peak value in a certain direction or angle, and the selection of a certain beam depends on a desired direction or angle. When a beam that is pointing in a direction to serve a particular receiving device, such as a UE, the UE may change its location which results the beam no longer pointing to the UE. Movement of the UE with respect to the beam may be more pronounced at higher frequencies and when the beams are narrower in order to provide higher gain to combat higher path loss experienced at higher frequency ranges.

In addition to beam angle, there are various other analog beamforming parameters that may be used in defining an analog beamformed beam. Beamwidth defines how wide a beam is while still providing a particular beamforming gain. The beamwidth may determine how much of the area around the UE may still have beamforming gain when the UE is moving. For example, the wider the beamwidth, the larger the area around the UE is covered by the beam and therefore the more the UE can move and still maintain some amount of beamforming gain.

Some systems may use chirp beams instead of DFT beams as chirp beams have a controllable beamwidth that can provide gains for a larger area. Therefore, the chirp beams may provide robustness against angular errors as the beam can still serve an area around the UE.

When the base station or UE has many antennas, these antennas can be arranged in many forms. For example, the antenna may be placed in a 1D linear array with equal spacing. Another way to arrange the antenna is to place the antennas in a 2D rectangular grid. For 1D arrays, DFT or chirp beams may be used for beamforming. When 2D arrays are being used, conventional methods typically use two 1D beams on each direction or axis of the rectangular grid. This arrangement can be represented by the Kronecker product of the two 1D beams to obtain the 2D beam. When beamforming in 2D is performed in this manner, the robustness of the 2D beam depends on the robustness of the underlying 1D beams. For example, if the 1D beams are horizontal and vertical beams, then the robustness that may be obtained is in a horizontal and/or a vertical direction, and it is not possible to obtain robustness in any other general direction.

The formation of beams when using the RIS to redirect beams may result in non-robust beams and when the RIS is redirecting the beam to a UE, there may be beam gain degradation when the UE changes location, or when there is higher uncertainty in knowledge of a direction the UE is heading. The beam gain degradation may lower the transmission rate. Methods for providing a robust beam when redirecting a beam using a RIS are provided. This may enable robustness in any direction that mitigates beam gain degradation when there is UE movement and/or when there is UE location uncertainty. In some embodiments, the RIS is integrated at the base station. In some embodiments, the RIS is a separate entity from the base station. Methods for signalling between the base station and RIS when the RIS is a separate entity from the base station are also provided that allow the RIS to redirect robust beams.

Methods are provided that enable the RIS to shape a beam being redirected by the RIS for robustness whether the RIS is integrated at the base station, or the RIS is a separate entity from the base station. For the scenario in which the RIS is integrated at the base station, or more generally a transmitting device, several implementation advantages are described. For the scenario in which the RIS is a separate entity from the base station, or more generally a transmitting device, signalling schemes are provided that enable robust beam generation.

In some embodiments, robust beams are described by 2D chirp beams, which have phase terms that correspond to the beam direction and other phase terms that correspond to the beam robustness. With regard to 2D chirp beams beamformed by a N₁×N₂ 2D antenna array, where N₁ and N₂ are integer values, of half wavelength separation, where the antennas of the array are indexed n₁ and n₂, phase terms e^{-jπn}^{₁}^{sin θ}^{₁} e^{-πn}^{₂}^{sin θ}^{₂} set the beam direction according to the θ₁ and θ₂. However, for robustness along different axes than the antenna array axes, the robustness phase terms will follow e^{-jπu}^{₁}^{d}^{₁}^{(d}^{₁}^{-D}^{₁}^{+1)/D}^{₁}e^{-jπ}^{₂}^{d}^{₂}^{(d}^{₂}^{-D}^{₂}^{+1)/D}^{₂}, where d₁ and d₂ are new indices of an alternative axes. In this case, D₁ and D₂ represent a range of indices for the alternative axes. In another format, the overall beam coefficients can be expressed as:

exp(−j(α₁n₁+α₂n₂+β₁₁n₁²+β₂₂n₂²+2β₁₂n₁n₂))

where the parameters α and β together determine a direction, width, shape and orientation of a resulting robust beam. In general, robust beamforming can be represented in a polynomial format of antenna phases as a function of the antenna indices or locations and/or of RIS element phases as a function of the RIS indices or locations. Further detail pertaining providing robustness in any direction as opposed to only the underlying direction of the axes of the array can be found in PCT application PCT/CN2021/133177 filed Nov. 25, 2021 that is assigned to the assignee of the present application.

When the RIS is integrated with the base station, the arrangement of the RIS with respect to the antennas may have several different arrangements. In some embodiments, the RIS can be a panel that is parallel to an antenna panel. In some embodiments, the RIS can be a panel that is inclined or even perpendicular to the antenna panel. In some embodiments, the antennas may be isotropic or directional. In some embodiments, the antennas may be halfwave length separated or more widely separated. In some embodiments, there may be more than one RIS panel reflecting the signal from one or more antenna panel. The RIS may be serving antennas having different operational frequencies, or different polarizations or that are operating in different time slots.

Different types of RISs may be made from different types of materials and use different technologies. A non-limiting list of examples include liquid crystal based RIS, micro electro-mechanical mirror (MEM) based RIS, and graphene based RIS. As a result, different types of RISs may each have a different response time than other RISs. It is to be understood that the basic principles described herein can be applied to various combinations of RIS and antenna arrays, and the examples described herein are illustrative in a non-limiting way.

The RIS has technical specifications that may affect how the RIS is capable of beamforming a signal received from the antenna array. One technical specification is a phase range that can be obtained be proper driving of the device. Driving of the device is intended to describe the manner in which individual elements of the RIS are configured to result in a phase change to the portion of a beam that impinges on that element. While some types of RISs that are capable of large phase ranges, these phase ranges are typically limited to a certain frequency range. The phase range may be smaller outside the certain frequency range. When the RIS phase range is limited, and a phase range is desired that is larger than the phase range that is feasible by the RIS, different phase approximations may be implemented that may have a lower overall performance than if the full desired phase range was available. Another technical specification is the speed with which a RIS element can switch from providing a first phase change to providing a second phase change. The switching speed may be technology dependent and may cause non-linear performance in some types of RISs.

In some embodiments, the combination of the RIS and array of antennas may be used to implement robust beams e.g., 2D chirp beams. In some embodiments, signalling between two devices, for example a base station to a UE or a UE to a base station, via the RIS or a different channel, may include an exchange of beam parameter information to aid in implementing robust beams. The signalling exchanged may also include information that affects configuring beamforming for the antenna array. Aspects of the disclosure presented here may be applicable for any type of link, such as uplink (UL), downlink (DL), sidelink (SL) or backhaul. A system using a combined array of antennas and RIS may be a system that a capable of frequency division duplexing (FDD) or time division duplexing (TDD). Because aspects of the disclosure relate to beamforming methods between the UE, the BS and the RIS, it should be understood that the BS and/or the UE could be a satellite, a drone, a vehicle, an internet of things (IoT) device, etc.

In some embodiments, the RIS is a separate entity from the array of antennas, or more generally, from the transmitter. In such a case, the RIS configures the RIS elements based on information used to implement a particular phase shift that is provided by the base station, or the network that the base station is a part of, through a dedicated control channel. The phase shift information may include information that can be used by the RIS to configure elements of the RIS and include information pertaining to beam direction, beam shape and beam robustness of the redirected beam. According to the phase shift information, the RIS determines how to configure the phase shift of each individual RIS element. The phase shift information may more generally be considered configuration information provided to the RIS.

The phase shift information provided to the RIS regarding the robust beams can be provided in various formats. In some embodiments, the base station, or network, sends information regarding the direction of beam re-direction separate from information regarding the beam robustness. In some embodiments, each of the beam re-direction information and the beam robustness information may be updated for a different frequency. In some embodiments, the base station, or network, may send information that is the combined beam re-direction information and the beam robustness information. In some embodiments, the base station, or network, may also send phase compensation information for other factors, e.g., distance related phase compensation. In some embodiments, the base station, or network, may also send information in terms of polynomial coefficient phase information that the RIS can use to determine the phases for the beam re-direction, beam robustness, phase compensation, or combinations thereof. In some embodiments, the base station, or the network, may communicate with the RIS regarding one or more UE, and the beam robustness requirement may be the same, or different, from one UE to another. In some embodiments, the amplitude of the signal being redirected by the RIS may be controlled by configuring the RIS elements of the RS in addition to the phase of the signal being redirected by the RIS being controlled by configuring the RIS elements.

The robust beams that result from configuring the elements of the RIS based on the information from the base station, or the network, may be determined in the form of a polynomial function of the RIS element indices or RIS element location. For example, chirp beams may be used in which the beam re-direction is defined in linear components of the polynomial function of the RIS element indices or RIS element location, and beam robustness is defined in linear and quadratic components of the polynomial function of the RIS element indices or RIS element location. One advantage of using chirp beams is that they may provide robustness in arbitrary directions, when appropriately configured, and they may have a compact representation that may use a narrow bandwidth control channel, which may reduce overhead. While the phase relation function has been described as being a polynomial function, it is to be understood that the phase relation function can take any other form than a polynomial function.

The robust beams that result from configuring the elements of the RIS may be based on information present at the base station, the UE, or both. In some embodiments, the UE sends the base station information, or one or more parameters, that are related to the robust beams to be generated through re-direction at the RIS and then the base station transmits the information, or one or more parameters, to the RIS so the RIS can use the information to configure the RIS elements. The base station may receive the information, or one or more parameters, from the UE via the RIS while using a default or an initial beam, or through another channel that may have similar, or a different, frequency band. In some embodiments, the base station may use its own sensing abilities to determine information, such as a UE location or a UE velocity, about the UE. The robustness of the beam may depend on various factors including, but not limited to, the UE location, UE velocity and expected UE trajectory (e.g., the road topography for vehicular users), the uncertainty in the UE or base station sensing estimates (for example the uncertainty of UE's location or velocity), the transmission reliability, and the capabilities of the base station and the RIS. In some embodiments, default values may be used for particular parameters of the beam.

The manner of information, or one or more parameters, sent by the base station to the RIS may depend on a beam management process. In some embodiments, the information, or one or more parameters, may depend on whether the beam is used for beam initial access, or beam refinement, or beam failure recovery. The manner of information, or one or more parameters, sent by the base station to the RIS may depend on whether the RIS re-directed beam is used for control communication or data communication, unicast/multicast or broadcast transmission or multi-beam transmission. The base station may provide information, or one or more parameters, for more than one beam. For example, the base station, or network, may send information, or one or more parameters, for one beam for initial communication, and information, or one or more parameters, for a refinement beam, or information, or one or more parameters, for multiple beams for different links to different users. In cases where the UE may be communicating with the base station with more than one beam through the RIS, the base station may send parameters for each beam, and the RIS may be divided into multiple portions in which each portion produces a redirected beam. In multi-beam communication, one or more beams may be for control purposes.

When the RIS configures the RIS elements based on information provided by the base station, or the network, the RIS may determine values to drive the RIS elements of the RIS to obtain a desired phase change based on a change to at least one of the beam direction, the beam shape, or the beam robustness. For example, a base station serving the UE through the RIS may update the entirety of the beam control information at the RIS each time there is a change, or the base station may partially update the beam control information. In some embodiments, the base station may update only the beam re-direction information for the RIS, while the RIS assumes that the beam robustness information is kept the same. Therefore, the base station may determine additional configuration information for the RIS due to a change in conditions (such as a change to at least one of the beam direction, the beam shape, or the beam robustness) and then the RIS uses the additional configuration information in combination with the original configuration information to determine a new configuration for elements of the RIS to redirect the signal transmitted by the array of antennas. In some embodiments, the phase compensation may be separately communicated with the RIS, and the RIS would consider these values for any subsequent beam control. The selection of phase and/or amplitude shift for each RIS element may be done by the network, by the RIS, or be divided between the two. In some embodiments, the selection of the beam is determined by the base station or the network, or the receiver or jointly by both. If the base station or the UE selects the beam, the respective device may provide all the phase values to the RIS, or the respective device reports only the polynomial coefficients to the RIS, or the respective device reports the beam shape, direction and/or orientation to the RIS and the RIS determines the beamforming in accordance with network instructions.

In some embodiments, the RIS may be equipped with active RIS elements that enable a sensing functionality and/or a receive functionality. When the RIS has a sensing and/or receive functionality, the RIS may have a capability to provide information to the base station or UE related to beam management. For example, the RIS may be equipped with sensing elements that enable measuring of a signal strength of a signal impinging on the sensing elements and accordingly, the RIS provides guidance on which beam to use based on the measurements. In such cases, it is possible that the phases of individual elements of the RIS may be set according to information that is partially from the RIS itself, rather than depending solely on the communication from the BS and/or UE.

When the RIS is a separate entity from the array of antennas, and the distance between the RIS and the array of antennas is not large when compared to the RIS dimension, or when the RIS is not a flat surface, the phases of an impinging wave from the array of antennas on the RIS elements may not have uniform phase spacing, i.e., a non-planer wave. In such a case, the phases configured for the RIS may be compensated by an extra phase component that would cancel the non-planar wave effect. The phases configured for the RIS, as instructed from the device associated with the array of antenna, for example the base station, or the network that the base station is a part of, may include phase compensation in addition to phase information relevant to the beam re-direction and beam robustness. In general, there may be several phase components that are communicated from the base station, or the network, to the RIS for enhancing the communication link, and those phase components may relate to beam re-direction, beam shape, beam robustness, and phase compensation.

The deployment of the RIS as a part of the link may be applied for different types of links, such as for UL, DL, sidelink and backhaul. While there are similarities in the application for the different types of links, the robustness requirements can be different from one type of link to another. For example, for DL, increased robustness may be desired because of the uncertainty in the UE location, while the base station and RIS locations are in many cases fixed and much less uncertain. However, in cases where the base station is mobile, for example, a drone, there may be a larger uncertainty and the robustness requirements may vary compared to a conventional tower-based base station. For UL, increased robustness may be desirable because of the uncertainty of the direction of the beam from the UE, rather than the beam from the RIS to the base station.

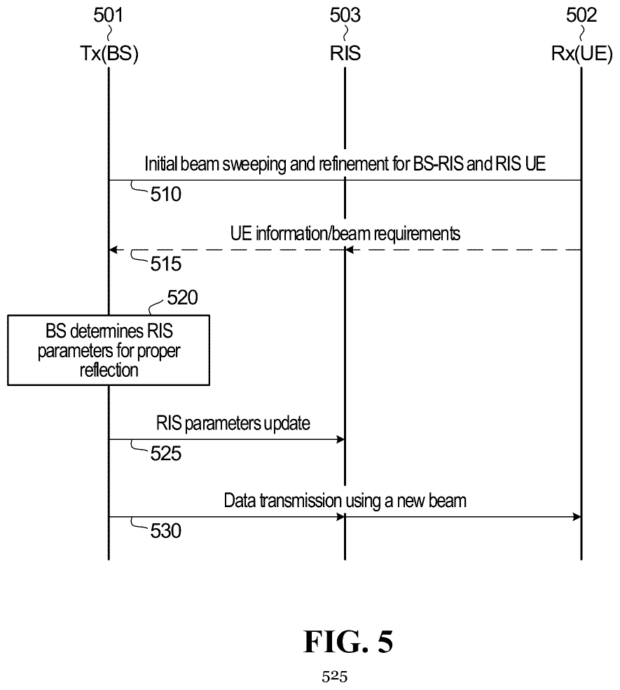

In FIG. 5, signaling is shown to occur between a transmitter 501, a RIS 503, and a receiver 502. In this example, the transmitter 501 is considered to be a base station and the receiver 502 is considered to be a UE. In some embodiments, signaling between the transmitter 501 and receiver 502 may be used to aid in determining parameters that the transmitter sends to the RIS 503 to enable the RIS 503 to redirect a beam with beam robustness. In this signaling example, the receiver 502 provides certain beam parameters that may be used to determine beam robustness following an initial beam sweeping for a DL scenario. Beam parameters suggested by the receiver 502 may be considered for refined beam sweeping. The transmitter 501 provides the RIS 503 with configuration information to realize robust beamforming with a signal is transmitted by the transmitter 501 and redirected by the RIS 503 to the receiver 502.

An initial step 510 includes initial beam alignment that may include initial beam sweeping and refinement between the transmitter and RIS and RIS and the receiver.

Step 515, is an optional step (as indicated by the dashed line) that involves the receiver 502 sending the transmitter 501 UE information and/or beam requirements that may be useful in determining configuration information for beamforming the signal by the RIS. In some embodiments, the UE information and/or beam requirements is sent on an uplink channel, in radio resource control (RRC) signaling, which may be a physical uplink control channel (PUCCH) or another physical channel.

At step 520, the transmitter 501 uses information known to the transmitter 501 and when available information provided to the transmitter 501 by the receiver 502 in step 515 to determine configuration information to be used by the RIS in configuring elements of the RIS to redirect the signal transmitted by the transmitter 501. The configuration information for redirecting the beamformed signal transmitted by the transmitter by the RIS 503 may be defined by parameters including one or more of an angle defining a beam center, parameter defining a beam width, and a shape representing a desired robustness shape.

At step 525, the transmitter 501 sends configuration information to the RIS 503 that can be used by the RIS 503 to configure the RIS elements to redirect a beam transmitted by an array of antennas at the transmitter 501.

At step 530, the transmitter 501 sends a data transmission to the receiver 502 via the configured RIS 503. In some embodiments, the data includes a demodulation reference signal (DMRS). In some embodiments, the downlink channel may be a physical downlink shared channel (PDSCH) or PDCCH or another physical channel.

Robust beams, e.g., chirp beams, depend on whether the transmitter has a one dimensional (1D) antenna array or 2D antenna array. In some embodiments, the RIS may be designed as a 2D array of reflective elements which enables the RIS to redirect signals from the transmitter antenna array with 2D robust beams; e.g., 2D chirp beams. For 2D beams, the beamwidth for each of the two dimensions can be independently adjusted. The robustness direction can be a rotated line, a horizontal line, a vertical line, an arc, or any other desired shape. Chirp beams may have an explicit beam width parameter for each dimension. In some embodiments, an RIS with phases that are already configured to redirect a beam in a certain direction, may receive instructions from the transmitter that add beam robustness to the redirected signal. The instructions may include beam parameters that are used by the RIS to compute the additional phase information to configure the RIS elements to achieve a desired beam robustness. In some embodiments, the beam parameters may be a chirp beam width and an angle such that the beam robustness is provided along a line having that angle with respect to a common reference line that is understood by the transmitter design for the desired beam robustness. The RIS translates the beam parameters received from the transmitter to the appropriate phases for a particular beam robustness, but may not necessarily understand such parameter information. In some embodiments, the transmitter sends polynomial coefficients that the RIS may use to calculate the phase shift for each element of the RIS as a function of the RIS element distance from the reference point that is known to the RIS.

The RIS redirects the signal transmitted by the antenna array by programming the RIS elements with specific phase shift information. When a number of the elements changes, the redirected beam shape may change as well. In some embodiments, the transmitter may send information that causes the RIS to turn off (or redirect in a different direction) some of the RIS elements or change the amplitude of the redirected signal in order to shape the redirected beam. Turning some of the RIS elements off or changing the amplitude may have the effect of changing the beamwidth of the reflected beam. This is another way to change the beamwidth, in addition to phase manipulation, that can provide control over the redirected beamwidth.

The transmitter may instruct the RIS with the information for redirecting more than one beam. The RIS may be also provided with information on how to divide the RIS elements into multiple groups, where each group may be responsible for the redirection of one beam, or the RIS may have a default configuration that can be initiated when instructed to use such a configuration. The different redirected beams may be redirected in different directions and have different beam robustness. Different redirected beams may be for communication or control.

For embodiments in which the RIS is a separate entity from the transmitter, when the RIS is provided with information that enables redirection of the beam with a particular beam robustness towards the receiver, a communication link between the transmitter and receiver may be by design robust to an uncertainty in collected information or receiver movements. This may provide better performance in terms of a higher SNR when the receiver moves or when compared to the performance when non-robust beams are used.

In some embodiments, the RIS is integrated with the antenna array. In some embodiments, the integrated antenna array and RIS are located at the base station. In some embodiments, the integrated antenna array and RIS are located at the UE, or an access point, or any other transceiver. The following discussion will focus on integration of antennas at the base station, as the base station usually has more physical space to deploy the integrated antenna array and RIS. The arrangement of RIS can have several different implementations. In some embodiments, the RIS is one panel that is parallel to antenna panel of the base station. In some embodiments, the RIS panel may be inclined or even perpendicular to the antenna panel of the base station. The RIS may be implemented in one or more panels that are close to the antenna panels of the base station. The antennas at the base station may be isotropic or directional, and may be halfwave length separated, or widely separated. In some embodiments, there may be more than one RIS panel reflecting the signal from one or more antenna panels. The RIS may be serving antennas operating in different operational frequencies, operating for different polarizations, and operating in different time slots. RISs may be made from different kinds of materials and using different technologies. Based on the different materials and technologies, different types of RISs may have a different response time than other types of RISs.

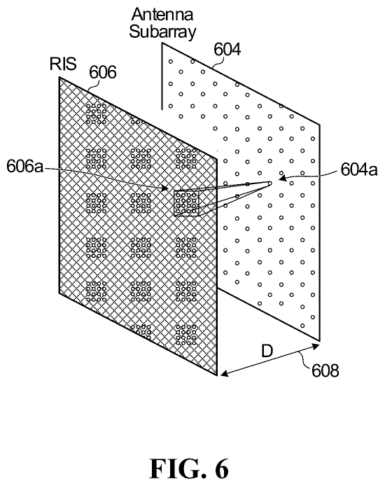

FIG. 6 is an example of when a subarray antenna panel 604 (of few elements, largely spaced) is integrated with a RIS panel 606. In the particular example of FIG. 6, the subarray antenna panel 604 has relatively fewer antenna elements, in comparison to the number of configurable elements in the RIS panel 606 and the antenna elements of the subarray antenna panel 604 are spaced apart to a larger degree than the configurable elements of the RIS panel 606. Each antenna element emits/radiates a signal that illuminates a subset of RIS configurable elements in front of it. An example of this is shown in terms of antenna element 604a of the antenna subarray panel 604 illuminating a plurality of configurable elements 406a. Some embodiments may utilize multiple subarray antenna panels arranged in an array, for example a 2×2 array of subarray antenna panels of a type shown in FIG. 6.

The distance between the subarray antenna panel 604 and the RIS panel 606 is D 608. The distance D may be chosen to enable (1) a sufficient gain, (2) reduce inter-illumination of same RIS elements from multiple antennas/subarrays or (3) adhere to practical limitations of the RIS, such as, for example, the sensitivity of the material to an incident angle of the signal impinging on the RIS. With reference to the expression “sufficient gain”, in some embodiments, this may mean 90% or more of the maximum gain.

When the RIS is integrated with the array of antennas, the distance from each antenna element generating a signal to a corresponding RIS element, or corresponding group of RIS elements, may vary. Accordingly, it may be desirable for some of the RIS elements to introduce phase compensation that is related to the distance between the RIS elements and the array of antennas. Compensating phases may be added in a cumulative manner to any phase changes be implemented for beam re-direction and beam robustness. In general, there may be phase compensation for different reasons and this phase compensation may be applied in addition to the phase changes used for beamforming.

When beamforming is performed for the RIS when the RIS is integrated with an array of antennas, the phases of the antennas and the reflection phases of the elements of the RIS are configured accordingly. For example, in a scenario in which there are M antennas in the antenna array and K RIS elements comprising the RIS, where M and K are integer values, K is typically greater than M to provide a higher gain at the RIS. Considering a resulting beam that is redirected by the RIS, the beam is a result of the K elements of the RIS and may be considered as the combination of K beam phases. Because an arbitrary phase can be multiplied by a whole beam without changing the direction of the beam, the phases describing the beam are practically K−1. However, due to having control over a combination of the M antennas phases in addition to the K RIS elements reflections, it may be possible to have additional degrees of a freedom to obtain a desired phase change that may not be able to be provided by the RIS alone.

Because for this embodiment in which the RIS is integrated with the antenna array at the base station, or more generally a transmitter, an over-the-air control channel to communicate between the base station and the RIS is not needed. Commands for the RIS can be directly linked between the base station and the RIS as the RIS is integrated and therefore in close proximity to the base station. Also, because each antenna element in the antenna array of the base station may interact with one or more RIS element of the RIS, the phase configuration for the integrated antenna array and RIS may be divided into two components, one first component that is realized by the base station antennas and a second component that is realized by the RIS elements. Accordingly, the same overall phase value can have various different implementations between what is realized by the antenna array and what is realized by the RIS. The total number of adjustable phases are the number of phases of all M antenna elements and all K RIS elements (for a total of K+M in this specific example), while the beam can be described by phases that have a dimension of the number of the RIS elements minus 1 (K−1 on this specific example). These extra phases (K+M−(K−1)=M+1) provide room for different implementation advantages. While the number of RIS elements of the RIS and the number of antennas of the antenna array at the base station are independent of one another, the RIS may have more elements than the antenna array has antennas, for example as illustrated in FIG. 6. The overall phase values may include phase compensation for reasons such as, but not limited to different distances between each RIS element phase shifting a wave and a corresponding antenna element transmitting this wave.

Robust beams may be generated by the integrated antenna and RIS structure. In some embodiments, robust beams may be modeled by phases that may be presented by a polynomial function of the RIS element indices or RIS element locations. For example, robust chirp beams can be used where the beam direction is based on linear phase components of the RIS element location, and beam robustness is based on linear and quadratic phase components of the RIS element location. An advantage of using the chirp beams is that such beams may provide robustness in arbitrary directions.

Robust beams may be based on information available at the base station, the UE, or both. In some embodiments, the UE sends the base station information or one or more parameters that are related to the robust beams to be generated. The base station may be informed of such information while using a default or an initial beam, or via a control channel that has a similar frequency band or a different frequency band compared to the data channel. The robustness of the beam may depend on various factors including, but not limited to, UE location, UE velocity and expected trajectory (e.g., the road topography for vehicular users), uncertainty in the UE sensing estimates (for example the uncertainty of its location or velocity), transmission reliability, and capabilities of the base station and the RIS. In some embodiments, default values may be used for some parameters of the robust beam.

The manner in which the base station configures RIS phase information may depend in part on a beam management process. For example, the configuration may depend on whether the beam is used for beam initial access, or beam refinement, or beam failure recovery. This is also related to whether the beam is used for control or data communication, unicast/multicast transmission, broadcast transmission, or multi-beam transmission. The base station may configure RIS phase information for more than one beam. For example, a first beam configuration may be for initial communication and a second beam configuration may be for a refinement beam. In cases where the UE might be communicating with the base station with more than one beam via the RIS, the base station may determine configuration parameters for each beam, and the RIS may partition the RIS elements into subsets of RIS elements to enable the RIS to redirect each beam. In some embodiments, for multi-beam communication, one or more beams may be for control purposes and a remainder of the beams for data transmission purposes.

Deployment of the RIS to strengthen a link between two communication devices may be applied to different types of links. For example, an RIS may be used for UL, DL and backhaul. While there are similarities in how an RIS may be configured for different types of links, robustness requirements may be different from one type of link to another. For example, in DL, robustness may be desired largely due to uncertainty of the UE location. In UL, robustness may be desirable due to uncertainty in a direction of the beam from the UE to the integrated RIS and antenna array at the base station. An RIS integrated with the base station may desire a robust connection when communicating using backhaul link from a first base station to a second base station when the first base station is a fixed location base station and the second base station is, for example, a drone or UAV.

When the antenna array and RIS are integrated at the base station, the desired overall phase may be divided into portions in which a first phase portion is provided by the antenna and a second phase portion by the RIS. Therefore, there can be many different sets of phases for the antennas and many different sets of phases for the RIS elements that result in the same beam. In some embodiments, the phase of each antenna element is chosen to limit the phase range of the RIS elements and still provide a desirable robust beam. A robust beam might be the same beam that may be produced when the phases of the RIS elements have a full phase range, or an approximate version of the beam with acceptable performance degradation that balances the available phase range and required performance. The phase range of the RIS is a hardware limitation that defines the possible phase ranges in different frequencies that can be efficiently implemented.

In some embodiments, the beam phase configuration information may be updated occasionally. Different phase components may be updated with different frequency. For example, the phase configuration information for elements of the RIS and for the antennas may be updated simultaneously at a lower frequency rate so that the phase switching at the RIS is less frequent. In some embodiments, the antennas of the antenna array may be updated at a higher frequency independently of the RIS elements. When the RIS and antenna phases are updated at the same time, they may be updated in any described way as discussed above. When the antennas are updated and the RIS phases are not updated, the phases at the antenna are updated so as to reduce the effect of phase mismatch when maintaining the RIS phase values for a new beam.

When the RIS is integrated with the antenna array at the base station, the RIS may provide a larger beamforming gain when the RIS is equipped with a larger number of elements that the number of antenna elements in the antenna array. This may enable robust beams with a balance between peak gain and robustness.

When antenna phases are set to enable a reduced RIS phase range, this may reduce the probability of the phase values at the RIS being outside the hardware capability, and accordingly decrease performance degradation related to mismatched phases.

When the RIS elements are updated at a lower frequency, this may relax the hardware switching requirement for the RIS. In such a case, the antenna phases may be set to reduce the phase mismatch of the RIS.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method of beamforming a signal comprising:
beamforming the signal to be transmitted, the beamforming comprising applying beam coefficients to a transmitter;
determining configuration information for a reconfigurable intelligent surface (RIS) enabling modification of the signal that impinges on the RIS; and
wherein the configuration information for the RIS pertains to beam direction, beam shape, and beam robustness of a redirected beam.

2. The method of claim 1, wherein the RIS is co-located with the transmitter, the method further comprising using the configuration information to configure the RIS.

3. The method of claim 1, wherein the RIS is located separately from the transmitter, the method further comprising transmitting the configuration information to the RIS.

4. The method of claim 3, further comprising using the configuration information received by the RIS to determine a configuration for elements of the RIS to redirect the beamformed signal.

5. The method of claim 4, wherein the configuration information used by the RIS to determine the configuration for the elements of the RIS comprises chirp beam information pertaining to the beam direction that is a linear function of indices of the elements of the RIS and information pertaining to the beam robustness that is a polynomial function of the indices of the elements of the RIS.

6. A method comprising:
determining configuration information for redirecting a beamformed signal by a reconfigurable intelligent surface (RIS),
wherein the configuration information pertains to beam direction, beam shape and beam robustness of a redirected beam.

7. The method of claim 6, wherein the RIS is located separately from a transmitter, the method further comprising transmitting the configuration information to the RIS.

8. The method of claim 6, wherein the configuration information for redirecting the beamformed signal by the RIS is defined by parameters including one or more of:
an angle defining a beam center;
a parameter defining a beam width; and
a shape representing a desired robustness shape.

9. The method of claim 6, further comprising receiving user equipment (UE) parameter information for use in determining the configuration information.

10. The method of claim 9, wherein the UE parameter information for use in determining the configuration information is one or more of:
a velocity of the UE;
a direction of movement of the UE;
a location of the UE;
interference measured at the UE;
a signal-to-noise ratio (SNR) calculated at the UE; or
uncertainty of one or more of the velocity of the UE, the direction of movement of the UE, the location of the UE, interference measured at the UE, or the SNR ratio calculated at the UE.

11. The method of any one of claim 6, wherein determining the configuration information is performed for more than one beam.

12. The method of any one of claim 6, wherein determining configuration information for the RIS includes determining a phase compensation component for at least one of:
when phase compensation is needed related to a distance between the RIS and a transmitter; or
when phases of the beamformed signal impinging on the RIS do not have uniform phase spacing.

13. A device of beamforming a signal, comprising:
at least one processor; and
at least one computer-readable medium having, stored thereon, computer executable instructions that when executed cause the at least one processor to:
beamform the signal to be transmitted, the beamforming comprising applying beam coefficients to a transmitter;
determine configuration information for a reconfigurable intelligent surface (RIS) enabling modification of the signal that impinges on the RIS; and
wherein the configuration information for the RIS pertains to beam direction, beam shape and beam robustness of a redirected beam.

14. The device of claim 13, wherein the RIS is co-located with the transmitter, and the computer executable instructions that when executed further cause the at least one processor to:
use the configuration information to configure the RIS.

15. The device of claim 13, wherein the RIS is located separately from the transmitter, and the computer executable instructions that when executed further cause the at least one processor to:
transmit the configuration information to the RIS.

16. The device of claim 15, the computer executable instructions that when executed further cause the at least one processor to:
use the configuration information received by the RIS to determine a configuration for elements of the RIS to redirect the beamformed signal.

17. A device, comprising:
at least one processor; and
at least one non-transitory computer-readable medium having stored thereon, computer executable instructions, that when executed cause the at least one processor to:
determine configuration information for redirecting a beamformed signal by a reconfigurable intelligent surface (RIS),
wherein the configuration information pertains to beam direction, beam shape and beam robustness of a redirected beam.

18. The device of claim 17, wherein the RIS is located separately from a transmitter, and the computer executable instructions that when executed further cause the at least one processor to:
transmit the configuration information to the RIS.

19. The device of claim 17, wherein the configuration information for redirecting the beamformed signal by the RIS is defined by parameters including one or more of:
an angle defining a beam center;
a parameter defining a beam width; and
a shape representing a desired robustness shape.

20. The device of claim 17, wherein the computer executable instructions that when executed further cause the at least one processor to:
receives user equipment (UE) parameter information for use in determining configuration information.
